(19) United States
(12) Patent Application Publication
(10) Pub. No.: US 2007/0195257 A1
(43) Pub. Date: Aug. 23, 2007

(54) LC imager panel assembly

(75) Inventors: Andrew Taylor, Santa Rosa, CA (US); Apurba Pradhan, Santa Rosa, CA (US); Gary Basey, Petaluma, CA (US); Christopher O'Hare, Santa Rosa, CA (US); Matthew W. Bellis, Yokohama (JP)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 11/358,605

(22) Filed: Feb. 21, 2006

(51) Int. Cl. G02F 1/13

(52) U.S. Cl. 349/187

(57) ABSTRACT

The invention provides an imager panel subassembly for use in an optical projection system. The subassembly includes a reflective imager panel, such an LCoS microdisplay, for spatially modulating an optical beam incident upon a front surface thereof for producing an image. An optically transparent birefringent trim retarder is disposed in front of the front surface of the imager panel for enhancing the image contrast, and for protecting the imager panel from the outside dust. The subassembly further includes a spacer separating the imager panel and the trim retarder for forming an enclosed airspace therebetween, and adjustable coupling means for securely coupling the trim retarder and the imager panel together in a pre-determined relative position independent of the optical projection system, so that to allow rotation of the trim retarder relative to the imager panel while maintaining dust-tight sealing of the enclosed airspace.

### CROSS-REFERENCE TO RELATED APPLICATIONS

Non-applicable.

### TECHNICAL FIELD

The present invention relates to liquid crystal (LC) or digital micromirror device (DMD) projectors, and more particularly to LC or DMD projectors incorporating an LC or DMD imager panel sub-assembly having an enclosed dust-sealed airspace in front of the imager panel.

### BACKGROUND OF THE INVENTION

Optical imaging systems typically include a transmissive or reflective imager, also referred to as a spatial light modulator, a light valve or light valve array, which imposes an image on a light beam. Transmissive light valves are typically translucent and allow light to pass through. Reflective light valves, on the other hand, reflect only selected portions of the input beam to form an image. Reflective light valves provide important advantages, as controlling circuitry may be placed behind the reflective surface and more advanced integrated circuit technology becomes available when the substrate materials are not limited by their opaqueness. Potentially inexpensive and compact liquid crystal display (LCD) projector configurations may become possible by the use of reflective liquid crystal microdisplays, e.g. employing liquid crystal on silicon (LCoS) chips, as the imager.

In a microdisplay-based optical projector, a microdisplay imager panel forms a pixilated image by spatially modulating light incident thereon, which is then projected onto an image screen by a projection lens with a magnification. Many reflective LCD imagers rotate the incident light polarization on a pixel-by-pixel basis by an angle depending on a relative brightness of a particular pixel in the image. In other words, polarized light is either reflected by the imager with its polarization state substantially unmodified for the darkest state, or with a degree of polarization rotation imparted to provide a desired grey scale. Typically, a 90° rotation provides the brightest state in these systems; a corresponding state of the imager is sometimes referred to as an “ON” state. Accordingly, a polarized light beam is generally used as the input beam for reflective LCD imagers.

Typically, the projected image of the microdisplay is magnified by a factor of 100 or larger. For front or rear projection, the pixels are typically on the order of 10 μm on the microdisplay and 1 mm on the projected screen image. Small defects on the imager surface can become magnified by the projection optics and thus diminish the image quality of the projected image. For example, a 10 μm defect could block the light from a single pixel. For this reason, a class 100 clean room environment must be maintained during the manufacturing of these microdisplay based projection systems.

Further, the imaged surfaces of the microdisplay must remain particle and dust free throughout the life of the projector. Dust that circulates through the projector, e.g. by an air cooling system, can settle on the imaged microdisplay surface and also be imaged onto the image screen, diminishing the image quality on the screen.

A variety of techniques have been proposed for sealing dust out of a projector. U.S. Pat. No. 6,280,036 describes a method of mechanically sealing a microdisplay imager to a field lens in order to eliminate dust. This method, however, may not be suitable for projectors based on color separation, wherein a single field lens is shared between several, typically three, microdisplay imager chips. U.S. Pat. No. 6,394,608 and US Patent Application 2002/0033992 A1 describe sealing the microdisplay imager and optical system inside a dust-proof box. A similar technique is proposed in U.S. Pat. No. 6,350,033. This approach, however, may require manufacturing of the whole optical system inside the box in a type 100 clean room environment, thereby substantially increasing production cost. Also, three-chip projectors often require adjustment on each of the red, green, and blue channels. Sealing the microdisplay chips in a dust sealed chamber prevents such adjustment.

US patent application 2005/0122482 discloses a projector incorporating a color-combining prism and a plurality of micro-displays for modulating light that passes through the prism, wherein the micro-displays are sealed against the prism with a dust-sealed air channels between the prism and respective micro-displays for cooling thereof. This solution is geared towards high-lumen applications, where forced air cooling of the imaged microdisplay surface may be required. It is also restricted to projection systems wherein microdisplay chips are positioned immediately next to the color-combining prism, and is not applicable to projection systems wherein the microdisplay imagers are positioned relatively away and/or at an angle to their respective prism surfaces. An example of such a projector is disclosed in U.S. Pat. No. 6,857,747, which is assigned to JDS Uniphase Corp., the assignee of the instant invention, and is incorporated herein by reference.

High-contrast LC optical projectors typically incorporate trim retarders next to the imager panels. A trim retarder compensates for residual retardation of the micro-display imager panel in a dark (OFF) state. Unlike typical birefringent waveplates providing ¼λ or ½λ retardation, a typical A-plate trim retarder provides between 1 nm and 50 nm of in-plane retardance. The primary benefit of introducing a trim retarder into a display system is to enhance image contrast, while not significantly degrading the ON-state brightness. Trim retarders incorporating both positive and negative birefringence to compensate for retardances resulting from LCoS display panels is disclosed in US Patent Application 2005/0128391, which is assigned to JDS Uniphase Corp., the assignee of the instant invention, and is incorporated herein by reference.

In a conventional LCoS display system, illustrated in FIG. 1, which is a copy of FIG. 1a of the aforecited US Patent Application 2005/0128391, one or more trim retarders 2 are positioned adjacent to an imager panel 3, typically having a less than an inch diagonal, for receiving a cone of polarized light 4, typically with a cone illumination of ±12 degrees, from a polarization beam splitter 5. The imager panel 3, in this case an LCoS chip, imprints an image information on the polarized light beam 4 by spatially modulating its polarization state, and reflects the spatially modulated beam back towards the beam splitter/polarizer 5, which transforms the spatial polarization modulation into a grey-scale spatial modulation of the output beam 6. A typical LCoS color display system includes three such image-imprinting units shown in FIG. 1, one for each of red, blue, and green light beams obtained from a beam of white light using color splitting filters, and one or two polarization combiners for combining the modulated red, blue and green beams into one colored beam, which is then projected onto a screen using a projection lens.

Conventional thermotropic liquid crystals in reflective LCoS imager panels are either twisted nematic, e.g. 45° twist (45TN), or vertically-aligned nematic (VAN-mode), which can be electrically switched, or relaxed, to a near homeotropic orientation. Other LC-modes also require trim retarders, if the LC-technology employs a dark-state director orientation near the homeotropic alignment. In the homeotropic alignment, the LC uniaxial positive molecules are oriented normal to the device plane. The dark, or OFF, state may be a switched state or a relaxed state, depending on LC modes. In most applications, a true homeotropic orientation in the dark state is not suitable, i.e. a pre-tilt is required to provide consistent and faster switching behavior.

As a consequence, the display panels exhibit both an in-plane and an out-of-plane residual retardation component, i.e. A-plate and C-plate components, respectively. The C-plate component is typically positive, thereby adding to the net panel retardance at off-axis illumination. Accounting for the imager panel and the light engine characteristics, the residual retardation compensation can be broadly divided into two steps: first, the in-plane retardation component of the imager panel is negated by aligning an A-plate component with an optic axis of the imager panel, which is also the c-axis, at 90° relative azimuth, and then improving the field of view by removing the out-of-plane retardance of the imager with a negative C-plate retarder component.

Importantly, a fine-tuning of the mutual alignment of polarization axes of the trim retarder and the corresponding imager panel is typically required after the projector assembly for obtaining optimum image contrast.

An object of the present invention is to provide a sealed imager panel subassembly having a dust-free space in front of an imaging surface of the imager, that can be assembled independently on the rest of the projection system.

It is another object of the present invention to provide a dust-sealed imager panel subassembly incorporating a rotatable trim retarder for adjustable residual polarization compensation.

### SUMMARY OF THE INVENTION

In accordance with the invention, an imager panel subassembly for use in an optical projection system is provided, comprising: a reflective imager panel having a front surface opposite to a back surface thereof, for spatially modulating an optical beam incident upon said front surface for producing an image; an optically transparent trim retarder for enhancing the image contrast, the optically transparent trim retarder disposed in front of the front surface of the imager panel; a spacer separating the imager panel and the trim retarder for forming an enclosed airspace therebetween; and, coupling means for securely coupling the trim retarder and the imager panel together in a pre-determined relative position independent of the optical projection system, so that the enclosed airspace is sealed for protecting said enclosed airspace from outside dust.

In accordance with one aspect of this invention, the coupling means of the imager panel subassembly for securely coupling the trim retarder and the imager panel is adjustable, so that to allow rotation of the trim retarder relative to the imager panel while maintaining dust-tight sealing of the enclosed airspace.

In accordance with another aspect of the present invention, the spacer comprises a front plate having an aperture opening for exposing the front surface to a polarized light via the trim retarder through said aperture, and the coupling means comprises means for holding the trim retarder against the front plate for covering the aperture opening and for allowing rotation thereof relative to the imager panel while maintaining a dust-tight seal around the aperture opening.

### BRIEF DESCRIPTION OF THE DRAWINGS

The invention will be described in greater detail with reference to the accompanying drawings representing preferred embodiments thereof, in which like numerals represent like elements, and wherein:

FIG. 1 is a diagram of a side view of a conventional LCoS imager panel assembly;

FIG. 2A is a perspective view of the LCoS imager panel subassembly according to a first embodiment of the present invention;

FIG. 2B is an exploded perspective view of the LCoS imager panel subassembly shown in FIG. 2A;

FIGS. 3A and 3B are perspective views of the imager panel subassembly shown in FIG. 2A, with a trim retarder rotated to opposite positions relative to the imager panel;

FIG. 4 is a diagram illustrating rotating of the trim retarder in the LCoS imager panel subassembly shown in FIGS. 2A, 3A and 3B;

FIGS. 5A, 5B and 5C are diagrams showing vertical cross-section of the imager panel subassembly shown in FIG. 2A;

FIG. 6 is a graph illustrating visibility of a particle image in dependence on the particle—LCoS panel distance for 10 μm and 100 μm particles.

FIG. 7A is a perspective view of the LCoS imager panel subassembly according to a second embodiment of the present invention;

FIG. 7B is an exploded perspective view of the LCoS imager panel subassembly shown in FIG. 7A;

FIG. 8 is a diagram showing a top portion of a vertical cross-section of the imager panel subassembly shown in FIG. 7A;

FIG. 9A is a perspective view of a simplified LCoS imager panel subassembly according to a third embodiment of the present invention;

FIG. 9B is an exploded perspective view of the simplified LCoS imager panel subassembly shown in FIG. 9A.

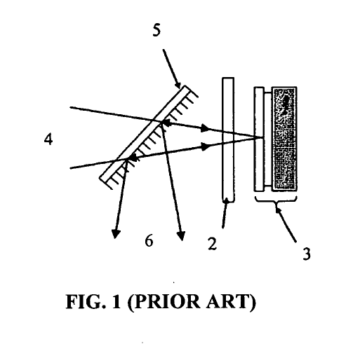

### DETAILED DESCRIPTION

Three exemplary embodiments of the imager panel subassembly will now be described. It should be noted that while various elements of these embodiments may be suitably coupled or connected to other elements within the exemplary embodiments, such connections and couplings can be realized by direct connection between elements, or by connection through other elements and devices located thereinbetween.

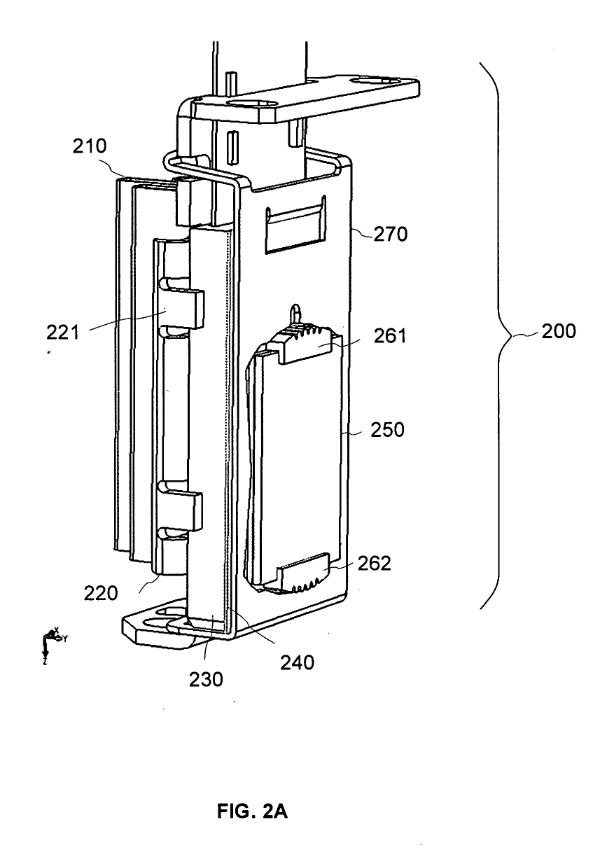

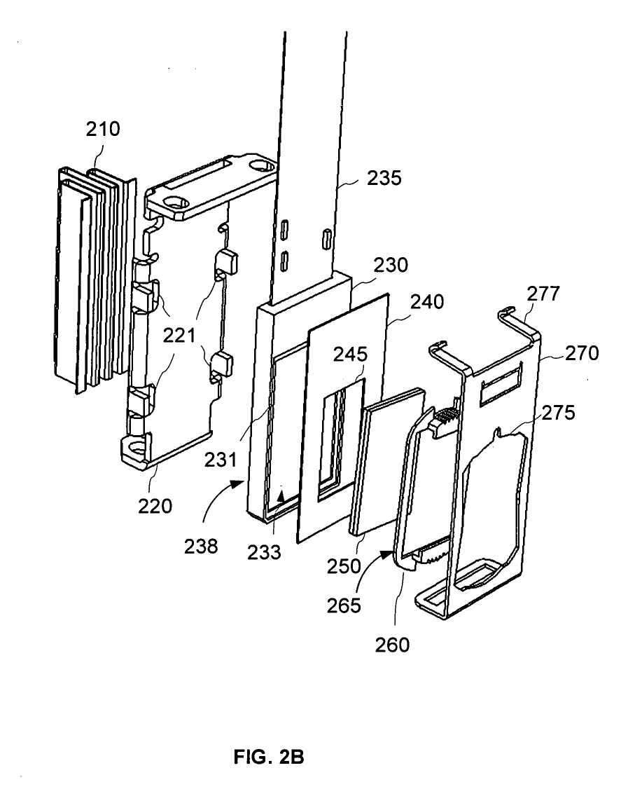

FIG. 2A shows a perspective view of the imager panel subassembly 200 according to a first embodiment of the invention, while FIG. 2B shows an exploded perspective view of the same embodiment to assist in the description thereof. As shown in these two figures, the subassembly 200 includes a reflective imager panel 230 with a flex cable 235, a front plate 240, an optically transparent window 250, a window frame 260, a window holding plate 270, a back plate 220 and an optional heat sink 210.

The imager panel 230 is embodied as a LCoS microdisplay; it has a front, or imaging surface 233, and a back surface 238 opposite thereto. The flex cable 235 is connected to the LCoS imager panel 230 for providing electrical video signals to the LCoS chip for controlling LC pixels of the imager panel 230, as it is conventionally done in LCoS-based microdisplays.

In operation, a polarized light beam, not shown in the figures, impinges upon the front surface 233 of the LCoS imager panel 230, passes through a pixilated LC layer beneath the front surface 233, and is reflected back from reflective electrodes imbedded in the imager 230 under the LC layer, so that the reflected beam carries image information imparted on it by the pixilated LC layer via spatial modulation of the beam polarization. The front surface 233 of the imager panel 230 is also referred to herein as an imaging surface. The LCoS imager panels described in this specification, such as the LCoS imager panel 230, are also referred to hereinafter as imager panels, or simply imagers.

The LC layer of the LCoS imager panel 230 is preferably protected by a thin cover glass 231, which is typically about 0.5 mm to 1.1 mm thick. The imaging surface 233 of the imager panel 230 is understood herein to be an outer surface of the cover glass 231. Note that the imaging surface 233, as defined hereinabove, should not be confused with an imaging plane of the imager 230, which is commonly understood in the art to be a plane of the beam reflection directly beneath the LC layer of the imager panel.

The front plate 240 is disposed in front of the imaging surface 233 of the imager panel 230, and is held juxtaposed thereto in a fixed position. It has an opening 245 forming an aperture for exposing at least a portion of the imaging surface 233 to the polarized light beam. The optically transparent window 250 is held against the front plate 240 fully covering the aperture opening 245, so that an enclosed airspace is formed within the aperture opening 245 between the window 250 and the imaging surface 233 of the imager panel 230. The front plate 240 functions as a spacer between the front surface 233 of the imager 230 and the window 250, so as to form the enclosed airspace therebetween and, simultaneously, as a circumferential gasket protecting the enclosed airspace from the dust.

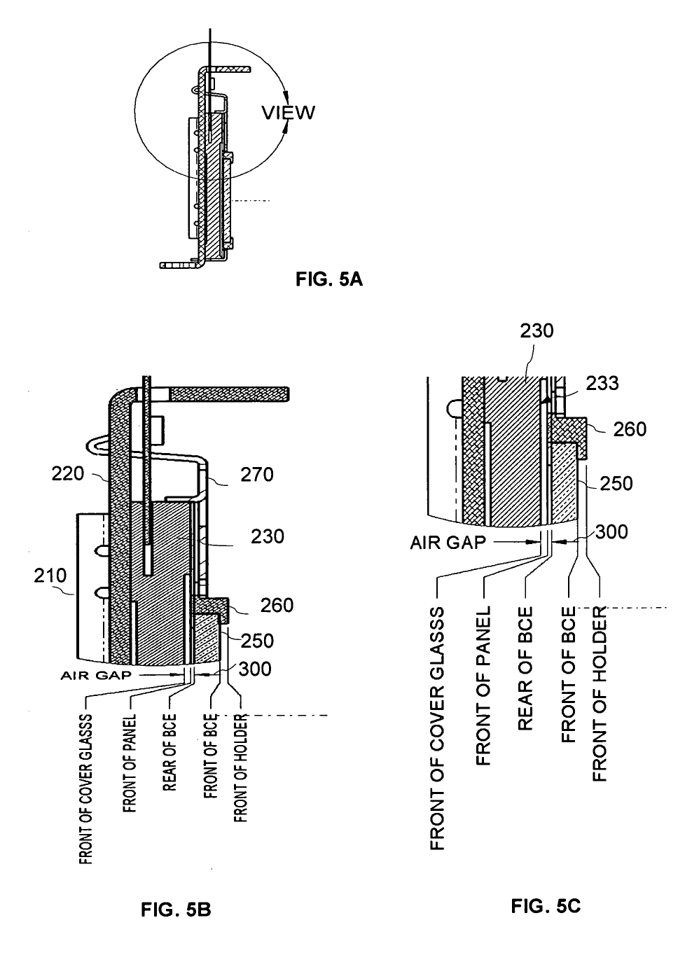

The enclosed airspace between the imager 230 and the transparent window 250, also referred to hereinafter as the airgap, is an important feature of the present invention. It will be discussed more in detail hereinafter in the specification with reference to FIGS. 5A-5C, showing a vertical cross-section of the imager subassembly 200, where the airgap is indicated with arrows labeled with a numeral “300”.

In a preferred embodiment, the optically transparent window 250 is a birefringent trim retarder plate, which improves image contrast by compensating a residual retardance of the LCoS chip in a dark state, as described hereinabove in the Background section of this specification. Hereinafter, the trim retarder 250 will also be referred to as a birefringent contrast enhancer, or BCE 250. The trim retarder 250 preferably includes at least one C-plate and at least one A-plate for compensating an in-plane and an out-of-plane components of the residual retardance of the imager panel 230, respectively, said A plate and C plate preferably sequentially coupled together to form a monolithic plate. Unlike a conventional ½λ waveplate, the trim retarder 250 provides only about 1 nm to 50 nm of retardance. US Patent applications 2005/0128380 in the names of Zieba et al, and 2005/0128391 in the names of Tan et al, both assigned to JDS Uniphase, the assignee of the current application, which are incorporated herein by reference, provide examples of polarization controlling elements and birefringent trim retarders that can be used as the trim retarder 250.

For optimized performance, an in-plane retardation component of the trim retarder has to be aligned in a pre-determined azimuthal orientation, e.g. 90° relative to the in-plane birefringent optical axis of the imager panel 230, see e.g. the US patent application 2005/0128391 incorporated herein by reference. Advantageously, the present invention provides means for performing this alignment outside a clean-room environment after fully assembling therein the imager subassembly, by rotating the trim retarder 250 in a plane parallel to the imaging surface 233. The angular adjustment of the trim retarder 250 can be performed in a dust-sealed configuration of the subassembly, wherein the enclosed airspace in front of the imager panel 230, and the front surface 233 thereof are protected from outside dust, as described more in detail hereinafter in this specification.

The transparent trim retarder 250 is held in the window frame 260 in a fixed position relative thereto; the trim retarder 250-frame 260 sub-assembly is referred hereinafter as a framed trim retarder 250/260. The window frame 260 has outer “shoulders” 265 about the transparent trim retarder 250. The holding plate 270, embodied herein as a clip frame with an opening 275 for the trim retarder 250, holds the window frame 260 by pressing against the frame shoulders 265, so that to tightly couple together the trim retarder 250, the front plate 240, and the imager 230 by holding the framed trim retarder 250 pressed against the front plate 240 in a dust-tight contact thereto, and the front plate 240 against the imager 230, thereby forming a circumferential seal between the framed trim retarder 250 and the imager 230. This circumferential seal prevents outside dust from getting into the sealed space between the imaging surface 233 of the imager 230 and the transparent window 250.

The front plate 240 can be either fixedly attached to the imager 230, e.g. by bonding directly thereto with a low-modulus adhesive, or can be simply held in its position by resilient fingers 277 and a bent bottom portion of the holding plate 270 protruding below the front plate 240 and limiting movements of the front plate 240 in a vertical direction, and/or by friction due to the pressure applied thereupon by the plate holder 270 via the framed trim retarder 250/260.

The holding plate 270 can be coupled either directly to the imager panel 230, e.g. using two or more clamps or clips, or indirectly via a carrier or a holder holding the imager 230. In the embodiment shown in FIGS. 2A and 2B, the imager panel subassembly includes the back plate 220, which is secured in a pre-determined position relative to the front plate 240 facing the back surface 238 of the imager panel 230, so that the imager panel 230 is sandwiched between the front and back plates 240 and 220 respectively. The holding plate 270 is attached to the back plate using resilient spring fingers 277, which engage the back plate 220 via cut-outs therein. In other embodiments, the holding plate can be coupled to the back plate 220 using other suitable means, so that to hold the front and back plates securely and fixedly coupled together, while pressing the framed trim retarder 250 against the front plate 240.

In a preferred embodiment, the back surface 238 of the imager 230 is in a thermal contact with the back plate 220, for enabling heat dissipation under exposure to a high-power beam, when light absorption by the imager 230 can lead to overheating thereof. In some embodiments, the back plate 220 is attached to a heat sink 210, which may be cooled by a forced air flow within the projector. The back plate 220 preferably includes means for holding the imager panel 230 in a fixed position relative thereto. This means would be obvious to those skilled in the art, and may include a plurality of clamps or clips, such as e.g. four clip fingers 221 shown in FIGS. 2A, 2B, and/or a recess in the back plate 220 shaped to fixedly hold the imager panel 230 therein. A thermally-conductive low-modulus adhesive can be used between the back plate 220 and the imager panel 230, for mutually coupling thereof in a fixed position. The adhesive used herein is preferably selected to have an elastic modulus less than 3000 psi, to minimize stress in the imager panel 230. An example of the adhesive for attaching the imager panel 230 to the back plate 240 is commercially available 3M-DP105 Scotch-Weld™ Epoxy Adhesive, manufactured by 3M.

As shown in FIGS. 2A-4B, the opening 275 in the holding plate 270 is shaped so to allow rotation of the framed trim retarder 250/260 within said opening in a plane substantially parallel to the imaging surface 233. The window frame 260 is thereby rotationally movable within the opening 275 by sliding against the front plate 240, which is preferably made using low-friction material, said sliding being effected without jeopardizing the dust-tight seal between the framed window 250/260 and the front plate 240. The window frame 260 and the holding plate 270 together will also be referred hereinafter in this specification as means for holding the trim retarder 250 against the front plate 240; in this embodiment, said means for holding allow rotation of the transparent window 250 relative to the LCD panel 230 while maintaining dust-tight sealing of the enclosed airspace. This arrangement enables the alignment of the trim retarder 250 and the imager panel 230, while securely coupling the trim retarder 250 against the imager 230 in a pre-determined relative position once the alignment is accomplished. The back plate 220, the window frame 260 and the holding plate 270 form coupling means for securely coupling the trim retarder 250 and the imager panel 230 together in a pre-determined relative position independent of the optical projection system, so that the enclosed airspace is sealed for protecting thereof from outside dust.

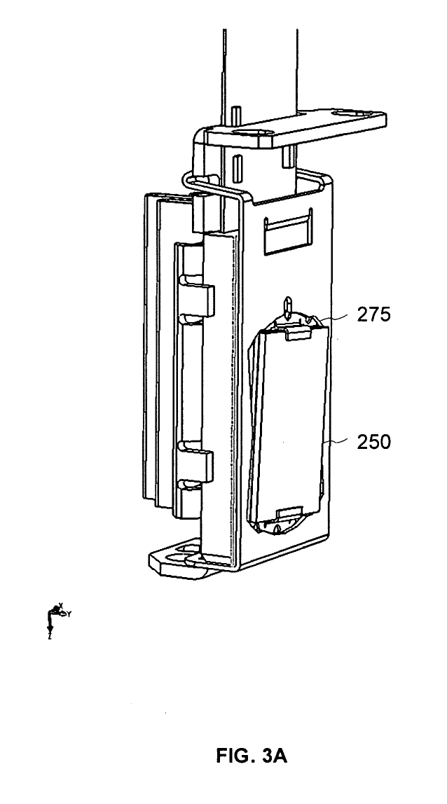

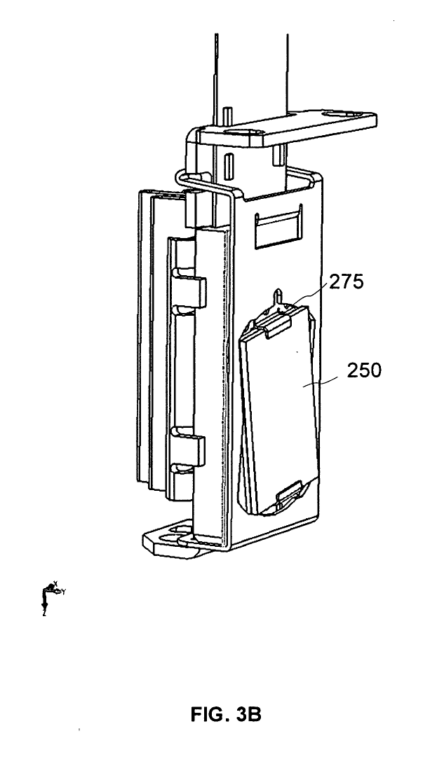

In one embodiment of the imager subassembly, an allowable rotation range is ±10° about a vertical position of the trim retarder 250; this range is typically sufficient for fine-tuning of the relative angular position of the trim retarder 250 and the imager 230 during assembly of the optical projector. FIGS. 3A and 3B illustrate positions of the trim retarder 250 within the opening 275 corresponding to the maximum allowable left and right rotation angles respectively.

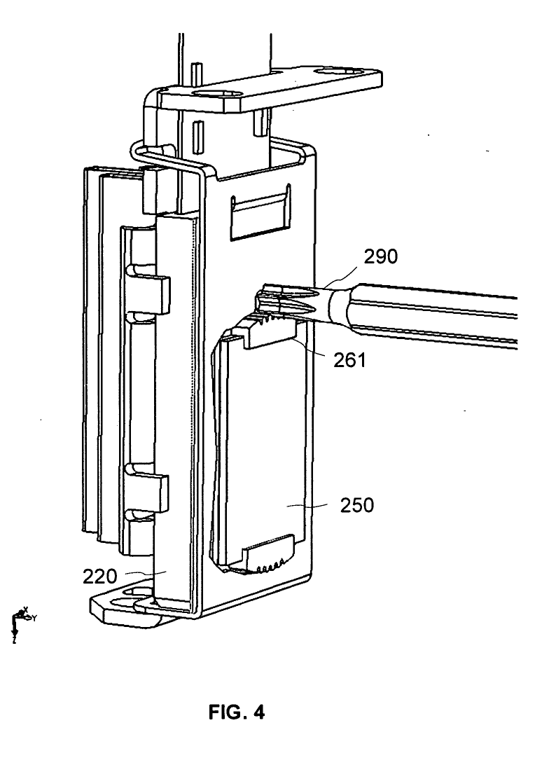

In the aforedescribed first exemplary embodiment, the movable window frame 260 holds the trim retarder 250 with two clip holders, which can be spring-loaded. In one embodiment, as shown in FIGS. 2A, 2B, and 4, these clip holders 261 and 262 have their outer edges shaped as a gear having a toothed surface, and can additionally serve as means for rotating the trim retarder 250 relative to the front plate 240. With reference to FIG. 4, rotation of the window 250 relative to the imager 230 is easily effected by engaging the gear clip 261 with a simple gear tool 290, which can be rotated e.g. by hand for adjusting the angular position of the trim retarder 250 relative to the imager 230 as required for optimal performance, e.g. during or after the projector assembly.

As stated hereinbefore with reference to FIGS. 2A and 2B, the front plate 240 preferably has a flat low-friction surface facing the trim retarder 250, for enabling said trim retarder to slidably rotate relative to the front panel 240, while maintaining a dust-tight contact with said surface when held against thereof by the holding plate 270. The front plate 240, or at least said low-friction surface thereof in contact with the window 250, is preferably formed using low-friction materials. A non-exclusive list of such materials includes: polyimide (PI), polyamide-imide (PAI), polybenzimidazole (PBI), polysulfone (PSU), polyetherimide (PEI), polyether sulfone (PES), polyaryl sulfone (PAS), Polyphenylene sulfide (PPS), Polyetheretherketone (PEEK), Fluoropolymers, Fluorinated ethylene propylene (FEP), Ethylene chlorotrifluoroethylene (ECTFE), Ethylene tetrafluoroethylene (ETFE), Polychlorotrifluoroethylene (PCTFE), Polytetrafluoroethylene (PTFE), Polyvinylidene fluoride (PVDF), Perfluoroalkoxy (PFA). By way of example, the front plate 240 is a 1 mm thick PTFE plate having a surface flatness better than 50 μm. The back plate 220 can be made of any suitable heat-conducting material, e.g. metal, as would be known to those skilled in the art. Similarly, the window frame 260 and the holder plate 270 can be made of any suitable resilient material such as metal, as also would be known to those skilled in the art. By way of example, the back plate 220, the frame 260, and the holding plate 270 are made of aluminum alloy 6061-T6.

In the hereinbefore described embodiments of the imager sub-assembly 200, the thickness of the front plate 240 determines the width of the airgap 300 between the BCE 250 and the imager panel 230. The airgap 300 is an important feature of the instant invention, and will now be addressed with reference to FIGS. 5A-5C. These figures give a planar view of a vertical cross-section of the imager subassembly 200 of the first embodiment of the present invention, wherein: FIG. 5A shows a full view of the cross-section, FIG. 5B shows a zoomed-in portion of the cross-section of FIG. 5A outlined by a circular arrow labeled “VIEW”, and FIG. 5C shows a further zoom-in onto a bottom portion of the cross-section shown in FIG. 5B.

As shown in these figures, the airgap 300 separates the front surface 233, also labeled as “FRONT OF THE COVER GLASS”, of the LCoS imager panel 230 from the BCE 250. This separation serves several important purposes. Firstly, the airgap 300 partially isolates the LCoS imager 230 from over-heating and stress, that could have otherwise be induced in the LCoS imager 230 by a contact with the BCE 250 during operation. Secondly, the airgap 300, when sealed from the outside dust, serves to reduce detrimental effects of the dust on the image quality.

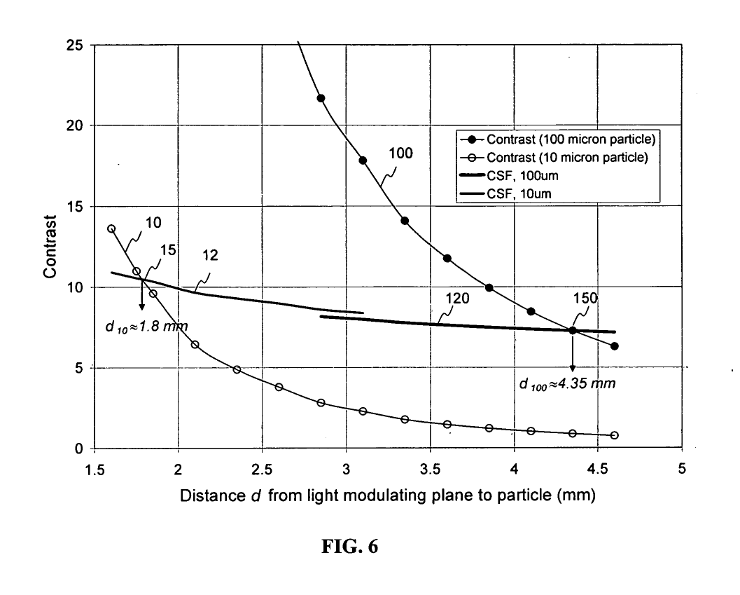

Indeed, moving a dust particle away from the front surface 233 of the LCoS imager 230 reduces an image contrast between the dust particle image and an image created by the LCoS imager 230 on the projection screen, due to a “blurring” of the particle image. As the particle moves away from the imaging plane of the imager 230, it becomes “out of focus” at the projection screen due to imaging properties of the projection lens. This image blurring, and hence the particle image contrast, can be computed using conventional methods from known optical properties of the projection lens system used in the projector. By way of example, FIG. 6 shows an estimated contrast between the image of the particle and the image created by the LCoS imager on the screen of a projection system, and its dependence on the distance d between the particle and the LCoS imaging plane, i.e. the interface between the LC layer and the underlying reflecting contact layer of the LCoS imager 230. A telecentric projection lens having a constant magnification factor M=98 is assumed, which collects a cone of light with an F/number of F/#=2.4 reflected from the LCoS imager 230. The image contrast C is defined herein as
C=I_{particle}/I_{LCoS},

where I_{particle} is an average irradiance of the screen within the particle image area due to light radiated from the LCoS panel 230, and I_{LCoS} is a screen irradiance outside of the particle image area due to the light from the LCoS panel 230. The LCoS imager 230 is assumed to be in an ‘ON’ state and the particle is obstructing/shadowing light from reaching the projection lens due to its transmission and/or polarization properties. Curves 10 and 100 show the estimated image contrast for screen images of particles having a diameter of 10 μm and 100 μm, respectively, in dependence on the particle distance d from the imaging plane of the LCoS imager 230; the particles are assumed to be fully absorbing, non-scattering, and centered in the field of view of the projection lens.

As the curves 10 and 100 demonstrate, the particles image contrast, and therefore—their visibility to an observer, rapidly decreases as the particle-imaging plane distance d increases beyond a few millimeters. To estimate when the particle image becomes invisible to an average human observer, the particle image contrast curves 10, 100 should be compared to a contrast sensitivity function (CSF) of a human eye, which has been extensively studied in the art; this function is represented in FIG. 6 by a visibility curve 12 for the 10 μm particle, and a visibility curve 120 for the 100 μm particle. The CSF, also referred to in the art as the visual acuity, describes the sensitivity of a human eye to low contrast patterns. It is obtained in human-factor experiments by determining a lowest value of the image contrast, for which the image is still visible, i.e. distinguishable from a uniform field, by a typical human eye. Typically, images of periodic line patterns of varying spatial frequency are viewed by a variety of human observers, and the visibility-threshold contrast values reported by the observers are averaged; the results are then used to obtain the CSF, defined as an inverse of the averaged threshold contrast, in dependence on the spatial frequency. More detailed description of the CSF, and experimental human CSF curves for images in red, green and blue light can be found, for example, in an article by Ramamurthy et al entitled “Determining Contrast Sensitivity Functions for Monochromatic Light Emitted by High Brightness LEDs”, Third International Conference in Solid State Lighting, 2004, Proceedings of SPIE 5187, pp. 294-300, which is incorporated herein by reference.

Turning back to FIG. 6, the visibility curve 12 represents an image contrast detection threshold for the 10 μm particle in dependence on the particle distance d from the imaging plane, i.e. it shows a minimum image contrast at which the 10 μm particle image can be seen by a viewer. Similarly, the visibility curve 120 represents a contrast detection threshold for the 100 μm particle in dependence on the distance d. In both cases, the viewer is assumed to be looking at the particle images on the screen from a distance l=0.5 meter.

The curves 12 and 120 were computed using the experimental human CSF data of Ramamurthy et al, as follows. First, image dimensions s₁₀(d) and s₁₀₀(d) for the 10 μm and 100 μm particles, respectively, in dependence on the distance d from the LCoS imaging plane, were calculated using the aforegiven exemplary parameter M of the imaging system and the blurring properties of the projection lens; second, spatial frequencies f₁₀(d) and f₁₀₀(d), in cycles per degree, were computed from the corresponding image sizes using the equations f₁₀(d)=1/(2·tan⁻¹(s₁₀/l)) and f₁₀₀(d)=1/(2·tan⁻¹(s₁₀₀/l)); next, the experimental CSF values given by Ramamurthy et al were extrapolated to obtain contrast values corresponding to the visibility threshold for the computed spatial frequencies; and, lastly, the so obtained contrast values for each of the 10 μm and 100 μm particles were plotted versus the distance d to obtain the curves 12 and 120, respectively.

In order for an image of the 10 μm particle located at a distance d from the imaging plane of the LCoS 230 to be visible on the screen by the viewer, the image contrast has to exceed the contrast detection threshold curve 12 for the particular distance d. Accordingly, an intersection point 15 of the curves 10 and 12 gives an estimate of a minimum separation value d₁₀ between the LCoS imaging plane and the 10 μm particle, at which the particle image becomes substantially invisible to the viewer looking at the image from a distance of 0.5 m. For the exemplary optical system parameters given hereinabove, this minimum separation d₁₀ is approximately 1.8 mm.

Similarly, in order for the 100 μm particle image to be visible, its contrast has to exceed the contrast detection threshold 120, and an x coordinate of the point 150 of intersection of curves 100 and 120 gives an estimate of a minimum separation value d₁₀₀ between the LCoS imaging plane and the 100 μm particle, at which the 100 μm particle image becomes substantially invisible to the viewer. For the exemplary optical system parameters given hereinabove, this minimum separation for a 100 μm particle d₁₀₀ is approximately 4.35 mm.

Advantageously, the insensitivity of a perceived quality of the image created on the screen by the LCoS 230 to the presence of 10 μm dust particles between the LCoS sub-assembly 200 having d>d₁₀ and the projection lens, enables assembling of the rest of the projection system, excluding the assembly of the imager sub-assembly 200, within a class 1000, or ISO class 6, clean room rather than within a class 100 (ISO class 2) clean room. The projection system insensitivity to the presence of 100 μm-size particles can further advantageously relax the assembly clean room requirements, and/or make the image quality less sensitive to other optical obstructions of this size located outside the imager subassembly 200. For example, micro-scratches of the front surface of the BCE 250, which can appear e.g. during the system assembly or repairs, are known to have a typical width on the order of 100 μm; therefore, having, in the imager subassembly 200, the front surface of the BCE 250 separated from the imaging plane of the imager 230 by a distance about or exceeding d₁₀₀˜4.35 mm, is advantageous for making the projection system's image quality insensitive to such scratches.

By way of example, in one embodiment of the sub-assembly 200, the cover glass 331 protecting the LC layer of the LCoS imager has a thickness d₀=0.5 mm and the BCE 250 has a thickness d_{BCE}=0.8 mm. In this case, the airgap 300 is preferably at least 0.5 mm thick to ensure that a 10 μm particle on an outer surface of the BCE 250, said surface labeled as “FRONT OF THE BCE” in FIGS. 5B, C, is substantially invisible to a typical viewer; however, the air-gap 300 should be at least about 3.1 mm thick to make the 100 μm particles and BCE surface defects substantially invisible on the screen.

In another example, the cover glass thickness d₀=1.1 mm, the BCE 250 thickness d_{BCE}=1.4 mm. In this embodiment, 10 μm particles located anywhere outside the imager subassembly 200 will be virtually invisible on the screen for any airgap 300; the minimum airgap 300 thickness corresponding to the 100 μm particle visibility threshold (d₁₀₀−d₀−d_{BCE}) is about 1.85 mm.

Generally, increasing the airgap 300 thickness will advantageously reduce the visibility of the dust defects on the projector screen, with an optimum distance depending on the size distribution of the dust particles within the projector and on optical properties of the imaging system, e.g. of the projection lens. A particular value of the airgap 300 thickness may be limited, however, by other constraints, such as those related to the overall design of the projector, and which would be known to a skilled in the art system designer; for example, it can be limited by a constraint on the overall thickness of the imager subassembly 200 in a particular projection system design; an optimal thickness of the airgap 300 would be clear to those skilled in the art for each particular application.

However, according to the present invention, the enclosed airspace between the BCE 250 and the imager 230 is preferably preserved in any projector design wherein the present invention is practiced, so that the airgap thickness 300 is at least 0.1 mm. The presence of the airgap 300 is advantageous for protecting the imager panel 230 from a direct contact with the BCE 250; such a contact is undesirable since it can lead to over-heating of the imager panel due to light absorption in the BCE 250, and can also result in mechanical deformations and appearance of stress in the imager 230, leading to an undesired stress-induces birefringence therein, and a loss of the image contrast. For these same reasons, the airgap should not be substituted with a transparent, i.e. glass, spacer, as it could adversely affect the imager's performance due to the imager's sensitivity to temperature and stress effects therein. A preferred value on the airgap 300 thickness is between about 1 and 5 mm in the embodiments described herein.

The aforedescribed imager panel subassembly 200 therefore provides the benefits of the dust protection similar to those provided by the prior-art solutions, e.g. those disclosed in U.S. Patent Application 2005/0122482, and U.S. Pat. No. 6,280,036. Importantly, it provides additional considerable advantages over the prior art solutions disclosed in the aforecited patents and other known prior art. Indeed, the solution of the present invention enables a significant reduction in time and complexity of the assembly that has to be performed in class 100 clean room environment, thereby reducing manufacturing time and cost. Indeed, in the prior art solutions, a significant number of optical elements had to be assembled together before a resulting rather complex assembly can be dust-sealed; typically, these optical elements include all three imager panels, a beam-splitting centerpiece including at least one beam splitter and, possibly, lenses. Contrary to that, the solution of the present invention provides a separate relatively simple dust-tight subassembly, e.g. the subassembly 200, for each individual LCoS panel 230, so that the rest of the projector can be assembled outside of the clean room, or in a clean room of a lower “cleanness” standard, e.g. in a class 1000 clean room.

Next, the imager subassembly of the present invention advantageously includes the trim retarder 250, which, in addition to functioning as a contrast enhancer, serves also as an optically transparent window providing an optical path to the LCD imager 230, while assisting in sealing the imaging surface 233 of the imager 230 from dust.

Furthermore, the present invention provides the imager subassembly wherein the angular orientation of the trim retarder 250; or the BCE, relative to the imager 230 is adjustable without jeopardizing the dust-tight sealing of the imager subassembly. This unique feature of the preferred embodiment of the invention enables fine-tuning of the LCoS imager performance outside of the clean room environment, thereby further simplifying the projector assembly and calibration; it also enables post-production adjustments of the BCE-imager alignment for optimizing image contrast.

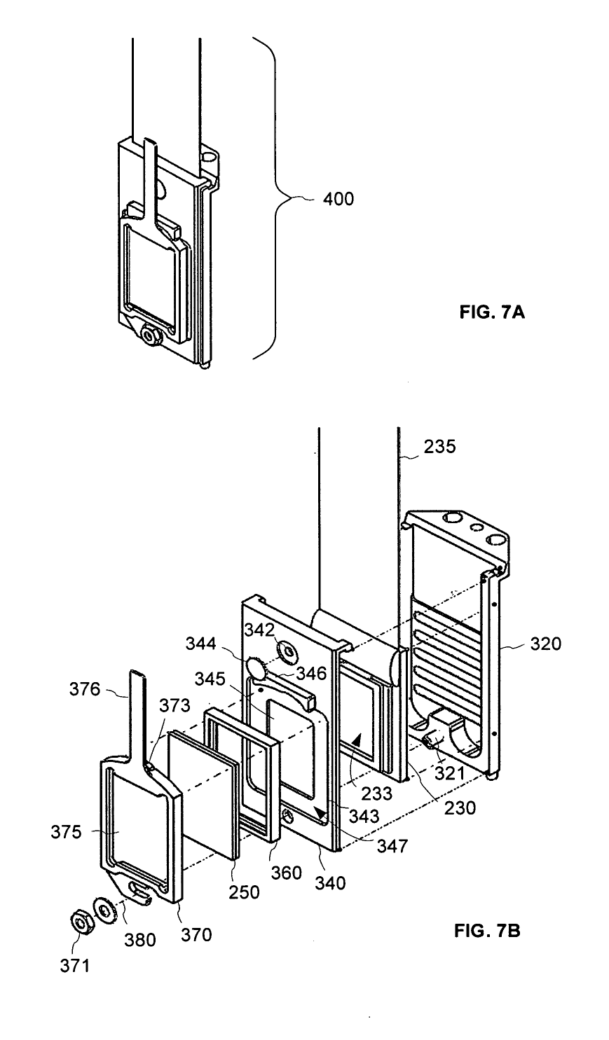

Of course, other embodiments of the imager-BCE subassembly of the present invention can be realized, that posses some or all of the aforedescribed important advantages of the invention. Two of them will now be briefly discussed with reference to FIGS. 7A-9B.

Similarly to FIGS. 2A, B, FIG. 7A shows a perspective view of a second exemplary embodiment of the imager subassembly of the present invention, while FIG. 7B, given for clarity, shows an exploded perspective view thereof. The imager subassembly 400 includes essentially same, or similar, components that the imager subassembly 200 shown in FIGS. 2A and 2B, but with differing embodiments of the front plate 340, window/BCE frame 360, and the holding plate 370. The front plate 340, also referred to herein in this embodiment as a cover plate, has a recessed space 343 for the window frame 360 wherein the BCE 250 is held, said recess space 343 being large enough to allow a ±10 degree rotation of the framed BCE 250 there within. The recess space 343 also has an aperture opening 345, which provides access to the imager panel 230 for the light beam, and flat shoulders 347 against which the framed BCE window 250/360 is held. The flat shoulders 347 functions as a spacer separating the BCE 250 and the imager panel 230, and as a dust-tight sealing gasket when the framed BCE 250/360 is pressed against it. The front plate 340, or at least an outer surface of the shoulders 347 facing the window frame 360, is made of a low-friction material to allow a substantially friction-free sliding of said frame against said shoulders while maintaining a dust-free airspace between the imager 230 and the BCE 250, similarly to the aforedescribed first embodiment of the invention.

Differently from the first exemplary embodiment shown in FIGS. 2A, B, in this embodiment the holding plate 370, which tightly holds the BCE window 250 against the front plate 340, itself is rotateable around an axis 380 in a plane parallel to the imaging surface 233, and preferably includes means to facilitate said rotation, such as an arm 376. The holding plate 370 can be held against the front plate 340 using any kind of coupling or fastening means that allow the rotation thereof, as would be known to those skilled in the art. In the embodiment shown in FIGS. 7A, B, the holding plate is attached to the back plate 320 around the axis 380 with a pin 321 and a nut 371, with the top of the holding plate 370 being held tightly against the front plate 340 using a knob 373 which engages a laterally positioned brace 346 attached to the front plate 340.

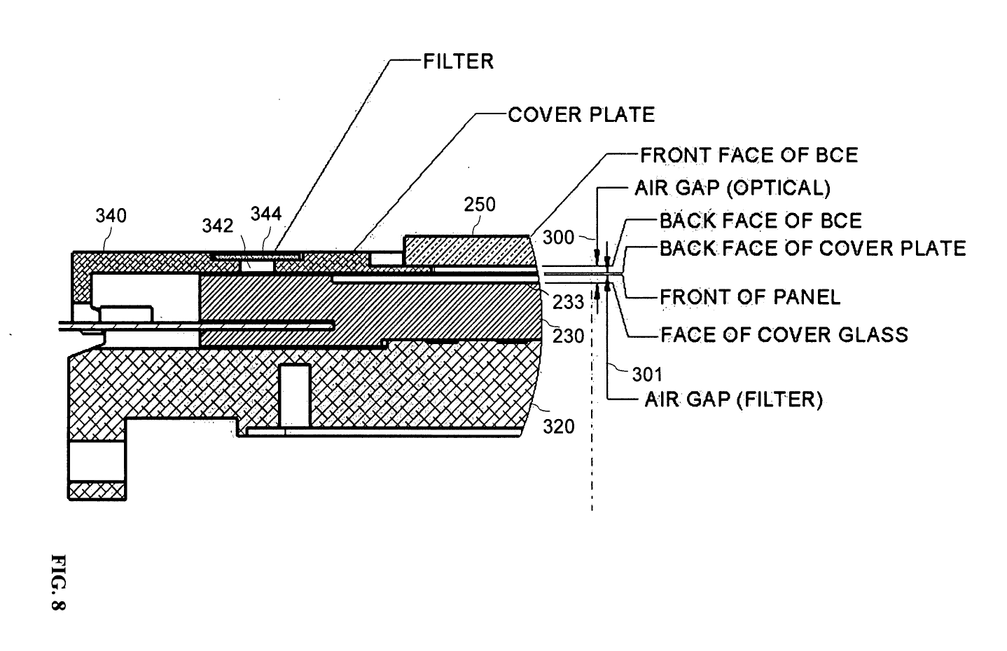

In some embodiments, the imager subassembly is sealed air-tight after the assembly thereof by applying a sealing agent, e.g. 3M's epoxy adhesive DP-105, circumferentially around the edges of the sub-assembly 400 to seal the contact areas between the front plate 340 and the back plate 320, and around the cable 235 opening at the top of the subassembly. In these embodiments, a vent hole covered with a dust filter, e.g a HEPA (high efficiency particulate arrestance) filter, is advantageously provided in the subassembly to ensure even air pressure inside and outside the dust sealed airspace and prevent associated mechanical deformations of any portion of the subassembly 400. In the embodiment shown in FIGS. 7A-B, the vent hole 342 is provided in the front plate 340, and is covered with the dust filter 344. This is further illustrated in FIG. 8, showing a vertical cross-section of a top portion of the subassembly 400; this figure shows the airgap 300, labeled herein “AIRGAP (OPTICAL)”, between the BCE 250 and the imager 230, which function has been described hereinabove with reference to the first embodiment of the invention, and an additional air gap 301 between the cover/front plate 340 and the top portion of the imager above the imaging surface, or face of the cover glass, 233. This second air gap, labeled in FIG. 8 as “AIRGAP (FILTER)”, provides an air path from the vent hole 342 to the enclosed airspace 300 in front of the imaging surface 233; it can be rather narrow, e.g. between few tens and few hundred microns thick.

The aforedescribed first and second exemplary embodiments of the invention both provide an important ability to tune the relative angular alignment of the LC imager 230 and the BCE 250 while still maintaining the dust seal therebetween. In preferred embodiments at least ±10 degree variation in the mutual alignment of the imager 230 and the BCE 250 is allowed, so that the A-plate of the BCE 250, which is a residual LC panel retardance compensator, can be individually tuned to each LCoS panel used in the manufacturing of the subassembly of the present invention as the imager 230, for compensating of small variations in the LC layer orientation parameters, and for improving thereby the yield of the microdisplay subassembly.

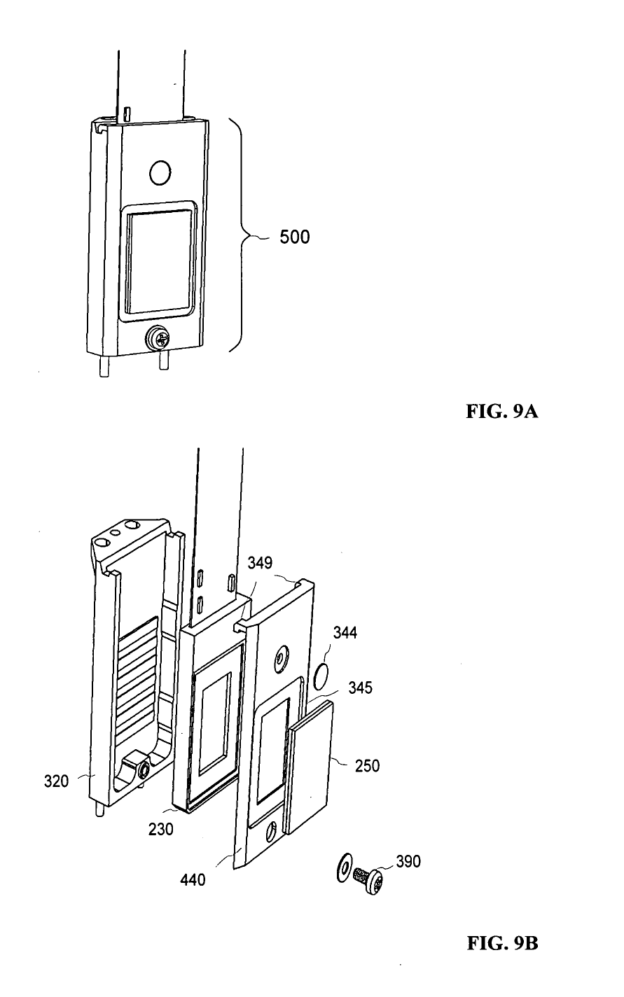

This feature can be omitted in some cases to simplify the subassembly, e.g. as the accuracy of the LCoS microdisplay chips alignment is sufficiently improved, so that alignment deviations from chip to chip are insignificant. FIGS. 9A, B illustrate a simplified version of the second exemplary embodiment of the invention. In this third exemplary embodiment, the subassembly 500 does not include a separate BCE/window frame, such as frame 360 in the second embodiment, or a separate plate holder, such as the plate holders 370 or 270, or any of the BCE rotating means. Instead, the BCE 250 is directly and un-movably attached to the front plate 440, e.g. with a low-modulus adhesive.

In this embodiment, the coupling means for securely coupling the trim retarder and the imager panel together in a pre-determined relative position independent of the optical projection system, so that the enclosed airspace is sealed for protecting thereof from outside dust, is formed by the adhesive, and any fastening means for attaching the front plate 440 to the back plate 320, such as the bolt 390, and two protruding fingers 349 of the front plate 440 for engaging the back plate 320, as shown in FIGS. 9A, B. The means for holding the trim retarder against the front plate for covering the aperture 345 in this embodiment is simply the adhesive that glues the BCE 250 to the front plate 440. The front plate 440 in this exemplary embodiment is shown to be similar to the front plate 340 of the second embodiment, except that it lacks means allowing the rotation of the BCE 250, such as the brace 346.

Of course, numerous other embodiments may be envisioned without departing from the spirit and scope of the invention utilizing all or some of the aforedescribed features of the present invention in various combinations; for example, it should be understood that each of the preceding embodiments of the present invention may utilize a portion of another embodiment.

The many features and advantages of the present invention are apparent from the aforegiven description and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described with reference to the three exemplary embodiments, and accordingly all suitable modifications and equivalents may be resorted to, falling within the scope of the invention.

We claim:

1. An imager panel subassembly for use in an optical projection system, comprising:
a reflective imager panel having a front surface opposite to a back surface thereof, for spatially modulating an optical beam incident upon said front surface for producing an image;
an optically transparent trim retarder for enhancing the image contrast, the optically transparent trim retarder disposed in front of the front surface of the imager panel;
a spacer separating the imager panel and the trim retarder for forming an enclosed airspace therebetween; and,
coupling means for securely coupling the trim retarder and the imager panel together independently of the optical projection system in a pre-determined relative position, so that the enclosed airspace is sealed for protecting said enclosed airspace from outside dust.

2. An imager panel subassembly according to claim 1, wherein the coupling means is adjustable, so that to allow rotation of the trim retarder relative to the imager panel while maintaining dust-tight sealing of the enclosed airspace.

3. An imager panel subassembly according to claim 1, wherein the front surface of the imager panel is spaced apart from the trim retarder by a distance of at least 0.1 mm.

4. An imager panel subassembly according to claim 1, wherein the trim retarder comprises at least one of an A-plate and a C-plate.

5. An imager panel subassembly according to claim 1, wherein the imager panel comprises a reflective LCD chip.

6. An imager panel subassembly according to claim 1, wherein:
the spacer comprises a front plate having an aperture opening for exposing the front surface to a polarized light via the trim retarder through said aperture,
the coupling means comprises means for holding the trim retarder against the front plate for covering the aperture opening and for providing a dust-tight seal around thereof.

7. An imager panel subassembly according to claim 6, wherein the trim retarder is affixed to the front plate with a low-modulus adhesive having an elastic modulus that is lower than or equal to 3000 psi.

8. An imager panel subassembly according to claim 6, wherein the means for holding the trim retarder allows rotation thereof relative to the imager panel while maintaining a dust-tight seal around the aperture opening.

9. An imager panel subassembly according to claim 8, wherein the means for holding the trim retarder comprises means for rotating the trim retarder relative to the front panel.

10. An imager panel subassembly according to claim 8, wherein the means for holding the trim retarder allows rotation of the trim retarder relative to the imager panel by an angle in a range of ±10 degrees in a plane parallel to the imaging surface of the imager panel.

11. An imager panel subassembly according to claim 8, wherein the front plate comprises low-friction material for allowing low-friction sliding of the trim retarder against the front plate while maintaining the dust-free sealing of the enclosed airspace.

12. An imager panel subassembly according to claim 6, wherein the front plate comprises at least one material selected from the group consisting of: polyimide, polyamide-imide, polybenzimidazole, polysulfone, polyetherimide, polyether sulfone, polyaryl sulfone, Polyphenylene sulfide, Polyetheretherketone, Fluoropolymers, Fluorinated ethylene propylene, Ethylene chlorotrifluoroethylene, Ethylene tetrafluoroethylene, Polychlorotrifluoroethylene, Polytetrafluoroethylene, Polyvinylidene fluoride, Perfluoroalkoxy.

13. An imager panel subassembly according to claim 6, further comprising a back plate facing the back surface of the imager panel and secured in a pre-determined position relative to the front plate, so that the imager panel is sandwiched between the front and back plates.

14. An imager panel subassembly according to claim 13, wherein the front and back plates are coupled together for forming a dust-sealed housing around the imager plate.

15. An imager panel subassembly according to claim 13, wherein the back surface of the imager panel is in thermal contact with the back plate.

16. An imager panel subassembly according to claim 13, wherein the imager panel is coupled to the back plate with a low-modulus thermally conductive adhesive having an elastic modulus that is lower than or equal to 3000 psi.

17. An imager panel subassembly according to claim 13, wherein the back plate has means for holding the imager panel in a fixed position relative thereto.

18. An imager panel subassembly according to claim 17, wherein the means for holding the imager panel includes at least one of a plurality of clamps and a recess in the back plate shaped to hold the imager panel therein.

19. An imager panel subassembly according to claim 6, wherein the means for holding the trim retarder comprises:
a movable trim retarder frame for holding the trim retarder therein, and
a holding plate for holding the movable trim retarder frame with the trim retarder therein against the front plate in a dust-tight contact thereto.

20. An imager panel subassembly according to claim 18, wherein the holding plate has an opening for the trim retarder allowing a rotation thereof within the opening in a plane substantially parallel to the imaging surface.

21. An imager panel subassembly according to claim 19, further comprising one of a gear or an arm coupled to the trim retarder for rotating thereof relative to the imager panel while maintaining the dust-tight sealing.

22. An imager panel subassembly according to claim 1, wherein the front plate has a vent hole comprising a dust filter for equalizing air pressure inside and outside of the enclosed airspace while ensuring dust-tight sealing thereof.
